(19) United States
(12) Patent Application Publication
(10) Pub. No.: US 2019/0276014 A1
(43) Pub. Date: Sep. 12, 2019

(54) VEHICLE CONTROL APPARATUS

(71) Applicant: Toyota Jidosha Kabushiki Kaisha, Toyota-shi (JP)

(72) Inventor: Yoshiaki Moriya, Susono-shi (JP)

(73) Assignee: Toyota Jidosha Kabushiki Kaisha, Toyota-shi (JP)

(21) Appl. No.: 16/293,829

(22) Filed: Mar. 6, 2019

(30) Foreign Application Priority Data
Mar. 8, 2018 (JP) 2018-042310

(51) Int. Cl. B60W 30/09; G05D 1/02; B60W 30/18

(52) U.S. Cl. CPC B60W 30/09; G05D 1/0214; B60W 2550/30; G05D 2201/0213; B60W 30/18163

(57) ABSTRACT

A vehicle control apparatus is provided with: an avoidance supporter configured to perform an avoidance support control for avoiding a collision between a host vehicle and an object; a determinator configured to determine, while the host vehicle is passing a front object, (i) whether or not a distance between a first part of the host vehicle and a second part of the front object is less than or equal to a predetermined distance threshold value, or (ii) whether or not a time required for the first part of the host vehicle to reach a position corresponding to the second part of the front object is less than or equal to a predetermined time threshold value; a detector configured to detect a re-entry intention of a driver of the host vehicle; and a controller programmed to control said avoidance supporter not to perform the avoidance support control.

### CROSS-REFERENCE TO RELATED APPLICATIONS

This application is based upon and claims the benefit of priority of the prior Japanese Patent Application No. 2018-042310, filed on Mar. 8, 2018, the entire contents of which are incorporated herein by reference.

### BACKGROUND

### 1. Technical Field

Embodiments of the present disclosure relate to a vehicle control apparatus configured to control the operation of a vehicle.

### 2. Description of the Related Art

There is known a technology/technique of appropriately suppressing or prohibiting various support controls, such as an alarm and a braking support, which are performed when a vehicle passes a preceding vehicle, according to circumstances. For example, Japanese Patent Application Laid Open No. 2009-137385 (Patent Literature 1) discloses a technology/technique of preventing that alarm generation and braking of a host vehicle are performed at an unnecessarily early stage if a vehicle temporarily passes into an opposite traffic lane for passing or the like. Japanese Patent Application Laid Open No. 2000-067394 (Patent Literature 2) proposes a technology/technique of suppressing or stopping a contact avoidance operation, which is performed by a contact avoiding device, if it is determined that a host vehicle is passing another vehicle.

As another related technology/technique, Japanese Patent Application Laid Open No. 2009-023399 (Patent Literature 3) discloses a technology/technique of arithmetically operating a collision time and a passing completion time on the basis of running states of a host vehicle, an oncoming vehicle, and a vehicle that is being passed, if the host vehicle or the oncoming vehicle is passing, thereby determining a probability of a collision between the host vehicle and the oncoming vehicle.

While passing, a driver may desire an early re-entry to the original lane, for example, in order to avoid the collision with the oncoming vehicle. In this case, the driver likely performs a steering control while requesting to maintain a speed or to accelerate a host vehicle. If the support control for avoiding the collision (e.g., a deceleration support control, an acceleration prohibition control, a steering prohibition control, etc.) is performed in this situation, the support control possibly increases a risk of the collision, instead of avoiding it. Such a case is not considered in any of the aforementioned patent literatures, and there is room for improvement.

### SUMMARY

In view of the aforementioned problems, it is therefore an object of embodiments of the present disclosure to provide a vehicle control apparatus that can appropriately perform an avoidance support control in the passing.

The above object of embodiments of the present disclosure can be achieved by a vehicle control apparatus provided with: an avoidance supporter configured to perform an avoidance support control for avoiding a collision between a host vehicle and an object that exists around the host vehicle; a determinator configured to determine, while the host vehicle is passing a front object that exists on a first driving lane, (i) whether or not a distance between a first part of the host vehicle and a second part of the front object is less than or equal to a predetermined distance threshold value, or (ii) whether or not a time required for the first part of the host vehicle to reach a position corresponding to the second part of the front object is less than or equal to a predetermined time threshold value; a detector configured to detect a re-entry intention of a driver of the host vehicle who intends to move the host vehicle ahead of the front object and a position in the first driving lane, if it is determined that the distance is less than or equal to the predetermined distance threshold value, or if it is determined that the time is less than or equal to the predetermined time threshold value; and a controller programmed to control the avoidance supporter not to perform the avoidance support control if the re-entry intention is detected.

### BRIEF DESCRIPTION OF THE DRAWINGS

FIG. 1 is a block diagram illustrating a configuration of a vehicle according to a first embodiment;

FIG. 2 is a flowchart illustrating a flow of operation of a vehicle control apparatus according to the first embodiment;

FIG. 3 is a top view illustrating an example of a passing distance Xt with a positive value;

FIG. 4 is a top view illustrating an example of a passing distance Xt of 0;

FIG. 5 is a top view illustrating an example of a passing distance Xt with a negative value;

FIG. 6 is a conceptual diagram illustrating a method of determining a re-entry intention by using an accelerator operation amount if a speed of a host vehicle is constant;

FIG. 7 is a conceptual diagram illustrating the method of determining the re-entry intention by using the accelerator operation amount if the host vehicle is accelerated;

FIG. 8 is a conceptual diagram illustrating the method of determining the re-entry intention by using the acceleration of the host vehicle;

FIG. 9 is a top view illustrating an operation section and operation prohibition section of a PCS control;

FIG. 10 is a flowchart illustrating a flow of operation of a vehicle control apparatus according to a second embodiment;

FIG. 11 is a flowchart illustrating a flow of operation of a vehicle control apparatus according to a third embodiment; and

FIG. 12 is a flowchart illustrating a flow of operation of a vehicle control apparatus according to a fourth embodiment.

### DETAILED DESCRIPTION OF THE EMBODIMENTS

Hereinafter, a vehicle control apparatus according to embodiments will be explained with reference to the drawings.

### First Embodiment

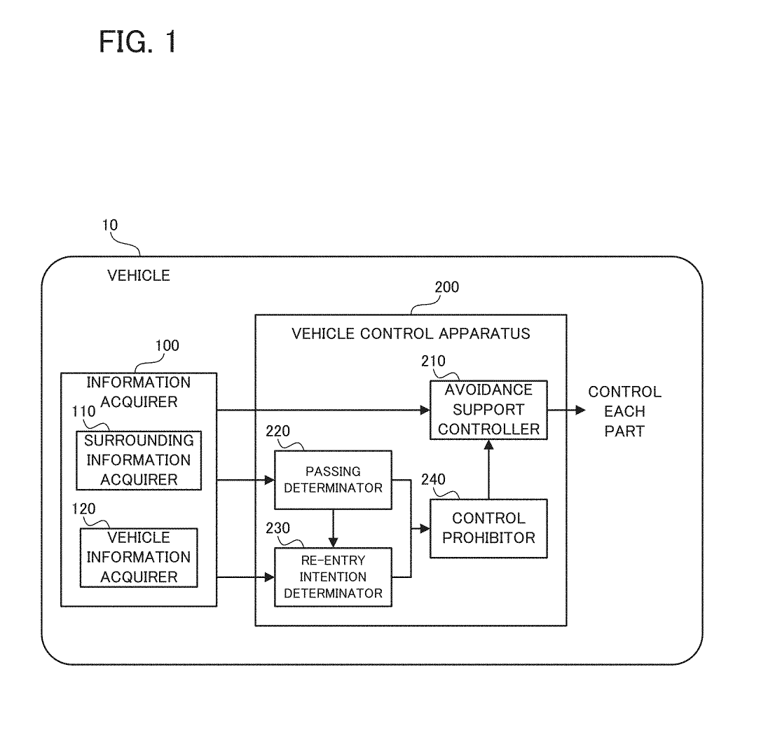

A vehicle control apparatus according to a first embodiment will be explained with reference to FIG. 1 to FIG. 9.

<Configuration of Apparatus>

Firstly, an entire configuration of a vehicle on which the vehicle control apparatus according to the first embodiment is mounted will be explained with reference to FIG. 1. FIG. 1 is a block diagram illustrating the configuration of the vehicle according to the first embodiment.

As illustrated in FIG. 1, a vehicle 10 according to the first embodiment is provided with an information acquirer 100 and a vehicle control apparatus 200.

The information acquirer 100 is provided with a surrounding information acquirer 110 and a vehicle information acquirer 120. The surrounding information acquirer 110 may include, for example, a vehicle exterior camera, a radar, a LIDAR (light detection and ranging), or the like, and is configured to obtain information about surroundings of the vehicle 10 (e.g., the presence/absence of an obstacle around the vehicle, a relative distance and speed with respect to the obstacle, etc.). The vehicle information acquirer 120 may include various sensors, and is configured to obtain information about the vehicle (e.g., a speed of the vehicle, acceleration, an accelerator operation amount, etc.).

The vehicle control apparatus 200 is a controller unit configured to control each part of the vehicle 10, and is particularly configured to perform an avoidance support control for avoiding a collision between the vehicle 10 and a surrounding object (e.g., another vehicle, a pedestrian, an obstacle, etc.). The vehicle control apparatus 200 is provided with an avoidance support controller 210, a passing determinator 220, a re-entry intention determinator 230, and a control prohibitor 240, as physical processing circuits or processing blocks for realizing its function.

The avoidance support controller 210 is configured to perform the avoidance support control of the vehicle 10, on the basis of various information obtained from the information acquirer 100. Specifically, the avoidance support controller 210 may control each part of the vehicle 10, thereby automatically controlling the driving of the vehicle 10 and supporting an operation performed by a driver, so that the collision between the vehicle 10 and the surrounding object is avoided. A specific example of the avoidance support control performed on the avoidance support controller 210 may include: for example, a PCS (pre crash safety) control including an automatic brake control or an alarm; and an acceleration suppression control; an automatic steering control; and so on. In the first embodiment, an explanation will be given to the PCS control, which is adopted as the avoidance support control. The avoidance support controller 210 is a specific example of the “avoidance supporter” in Supplementary Notes described later.

The passing determinator 220 is configured to determine whether or not the vehicle 10 is performing an operation of passing a front object positioned ahead of the vehicle 10 (e.g., a preceding vehicle, an obstacle ahead, etc.), on the basis of the information obtained from the information acquirer 100, and is configured to determine whether or not a distance or a time required for the vehicle 10 to pass the front object satisfies a predetermined condition. A specific content of the determination operation performed by the passing determinator 220 will be detailed later. A determination result on the passing determinator 220 may be outputted to the re-entry intention determinator 230 and the control prohibitor 240. The passing determinator 220 is a specific example of the “determinator” in Supplementary Notes described later.

The re-entry intention determinator 230 is configured to determine whether or not the driver of the vehicle 10 has a re-entry intention from the passing, on the basis of the information obtained from the information acquirer 100, if the vehicle 10 is performing the operation of passing the front object. For example, the re-entry intention determinator 230 may determine whether or not the vehicle 10 that has passed a preceding vehicle is about to move to a position ahead of the front object on a driving lane on which the front object exists. A specific content of the determination operation performed by the re-entry intention determinator 230 will be detailed later. A determination result on the re-entry intention determinator 230 may be outputted to the control prohibitor 240. The re-entry intention determinator 230 is a specific example of the “detector” in Supplementary Notes described later.

The control prohibitor 240 is configured to determine whether or not the avoidance support control by the avoidance support controller 210 is to be performed, on the basis of the determination results of the passing determinator 220 and the re-entry intention determinator 230, and is configured to control the avoidance support controller 210 not to perform the avoidance support control if it is determined that the avoidance support control is not to be performed on the vehicle 10; namely, the control prohibitor 240 is configured to temporarily prohibit the avoidance support control. A specific operation content of the control prohibitor 240 will be detailed later. The control prohibitor 240 is a specific example of the “controller” in Supplementary Notes described later.

<Explanation of Operation>

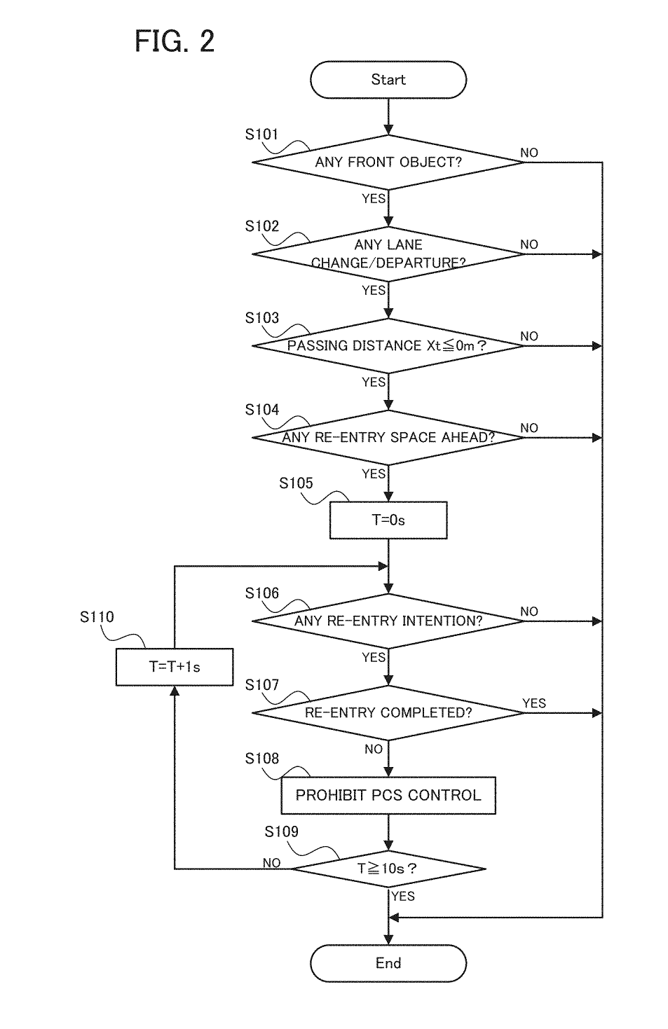

A flow of operation of the vehicle control apparatus according to the first embodiment will be explained with reference to FIG. 2. FIG. 2 is a flowchart illustrating the flow of the operation of the vehicle control apparatus according to the first embodiment.

As illustrated in FIG. 2, in operation of the vehicle control apparatus 200 according to the first embodiment, firstly, the passing determinator 220 determines whether or not there is an object that could be a passing target ahead (hereinafter referred to as a “front object” as occasion demands) of the vehicle 10 (hereinafter referred to as a “host vehicle 10” as occasion demands), on the basis of the information obtained on the information acquirer 100 (step S101).

If it is determined that there is no front object ahead of the host vehicle 10 (the step S101: NO), the subsequent process is omitted, and a series of steps is ended. In this case, the vehicle control apparatus 200 may restart the process from the step S101 after a lapse of a predetermined period. On the other hand, if it is determined that there is a front object ahead of the host vehicle 10 (the step S101: YES), the passing determinator 220 determines whether or not the host vehicle 10 performs a lane change or a lane departure (in other words, a relatively large move in a lane width direction intended for the passing), on the basis of the information obtained on the information acquirer 100 (step S102).

If it is determined that the host vehicle 10 performs neither a lane change nor a lane departure (the step S102: NO), the subsequent process is omitted, and a series of steps is ended. In this case, the vehicle control apparatus 200 may restart the process from the step S101 after a lapse of a predetermined period. On the other hand, if it is determined that the host vehicle 10 performs a lane change or a lane departure (the step S102: YES), the passing determinator 220 calculates a passing distance Xt, which is a distance required for the host vehicle 10 to be positioned ahead of the front object, and determines whether or not a value of Xt is less than or equal to 0 meters (step S103). The value “0 meters”, which is a threshold value here, is a specific example of the “predetermined distance threshold value” in Supplementary Notes described later, and is set as a value for determining whether or not the host vehicle 10 is positioned ahead of the front object.

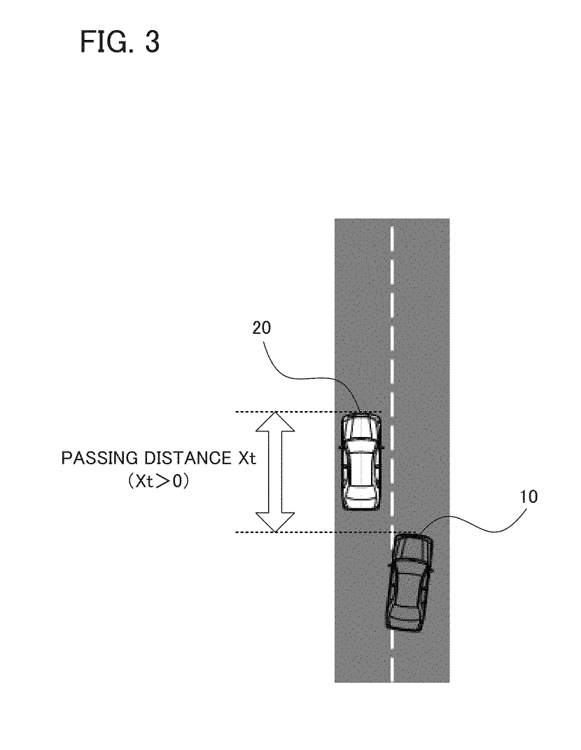

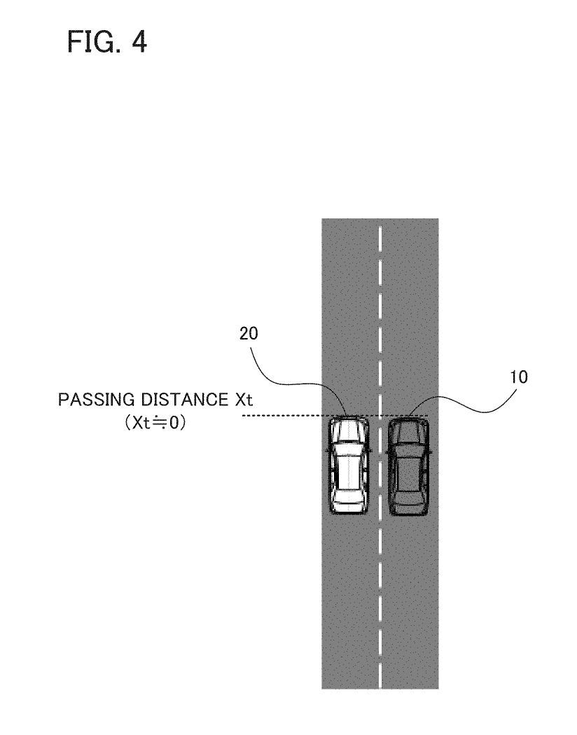

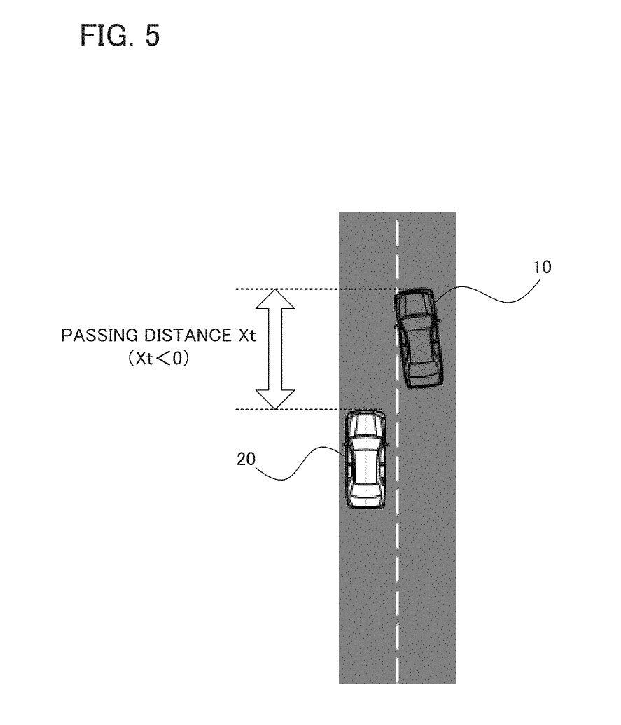

Now, a method of calculating the passing distance Xt will be specifically explained with reference to FIG. 3 to FIG. 5. FIG. 3 is a top view illustrating an example of a passing distance Xt with a positive value. FIG. 4 is a top view illustrating an example of a passing distance Xt of 0. FIG. 5 is a top view illustrating an example of a passing distance Xt with a negative value.

As illustrated in FIG. 3 to FIG. 5, if there is a preceding vehicle 20 as the front object ahead of the host vehicle 10, then, the passing distance Xt is calculated as a distance in a traveling direction between a front end of the host vehicle 10 (i.e., a front end in the traveling direction of the host vehicle 10) and a front end of the preceding vehicle 20. The front ends here are respectively specific examples of the “first part” and the “second part” in Supplementary Notes described later.

Specifically, as illustrated in FIG. 3, in a situation in which the host vehicle 10 is positioned behind the preceding vehicle 20, the passing distance Xt is calculated to have a positive value. As illustrated in FIG. 4, in a situation in which the host vehicle 10 is alongside the preceding vehicle 20, the passing distance Xt is calculated to be “0”. As illustrated in FIG. 5, in a situation in which the host vehicle 10 is positioned ahead of the preceding vehicle 20, the passing distance Xt is calculated to have a negative value. It is thus possible to easily determine whether or not the host vehicle 10 is positioned ahead of the preceding vehicle 20 by determining whether or not the passing distance Xt is less than or equal to 0 meters.

Whether or not the host vehicle 10 is positioned ahead of the preceding vehicle 20 may not be strictly determined from whether or not the front end of the host vehicle 10 is positioned ahead of the front end of the preceding vehicle 20. For example, even if the front end of the host vehicle 10 is positioned behind the front end of the preceding vehicle 20, if a distance between the vehicles 10 and 20 is less than or equal to a first predetermined distance, it may be determined that the host vehicle 10 is poisoned ahead of the preceding vehicle 20. Alternatively, even if the front end of the host vehicle 10 is positioned ahead of the front end of the preceding vehicle 20, if the distance between the vehicles 10 and 20 is not greater than or equal to a second predetermined distance, it may not be determined that the host vehicle 10 is positioned ahead of the preceding vehicle 20.

Moreover, the passing distance Xt may be calculated not on the basis of the front ends of the host vehicle 10 and the preceding vehicle 20, but on the basis of arbitrary reference positions of the vehicles 10 and 20. In other words, the passing distance Xt may be calculated as a distance between a reference position of the host vehicle 10 and a reference position of the preceding vehicle 20.

Back in FIG. 2, if it is determined that the passing distance Xt is not less than or equal to 0 meters (the step S103: NO), the subsequent process is omitted, and a series of steps is ended. In this case, the vehicle control apparatus 200 may restart the process from the step S101 after a lapse of a predetermined period. On the other hand, if it is determined that the passing distance Xt is less than or equal to 0 meters (the step S103: YES), the passing determinator 220 determines whether or not there is a re-entry space (which is a space to which the host vehicle 10 can move) ahead of the front object (step S104). In other words, the passing determinator 220 may determine whether or not the host vehicle 10 can re-enter the driving lane on which the front object exists and can complete a passing operation. If it is determined that there is no re-entry space ahead of the front object (the step S104: NO), the subsequent process is omitted, and a series of steps is ended. In this case, the vehicle control apparatus 200 may restart the process from the step S101 after a lapse of a predetermined period. On the other hand, if it is determined that there is a re-entry space ahead of the front object (the step S104: YES), a count T for determining a duration of the subsequent process (in other words, an end period) is initialized and is set to T=0 seconds (step S105).

Then, the re-entry intention determinator 230 determines whether or not the driver of the host vehicle 10 has a re-entry intention (i.e., an intention to move to the re-entry space) from the passing operation (step S106).

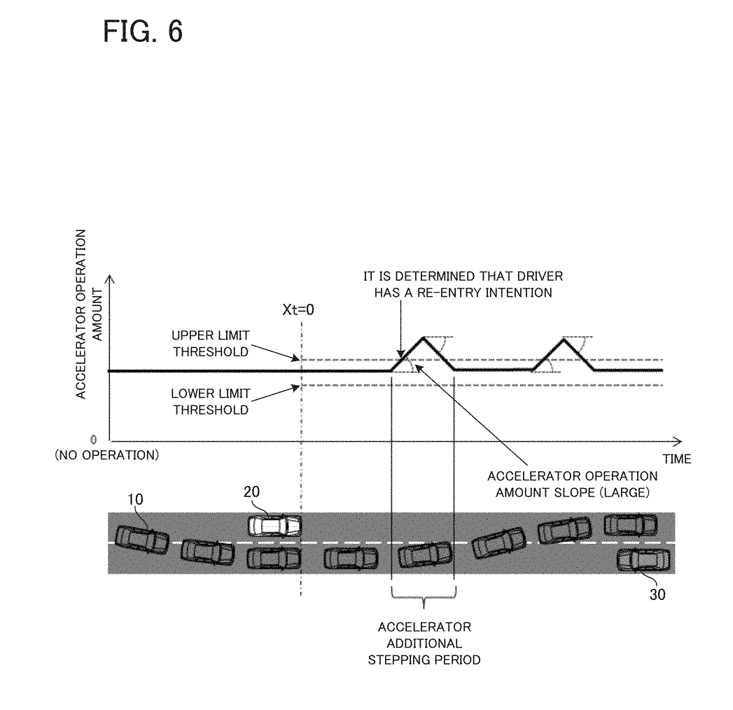

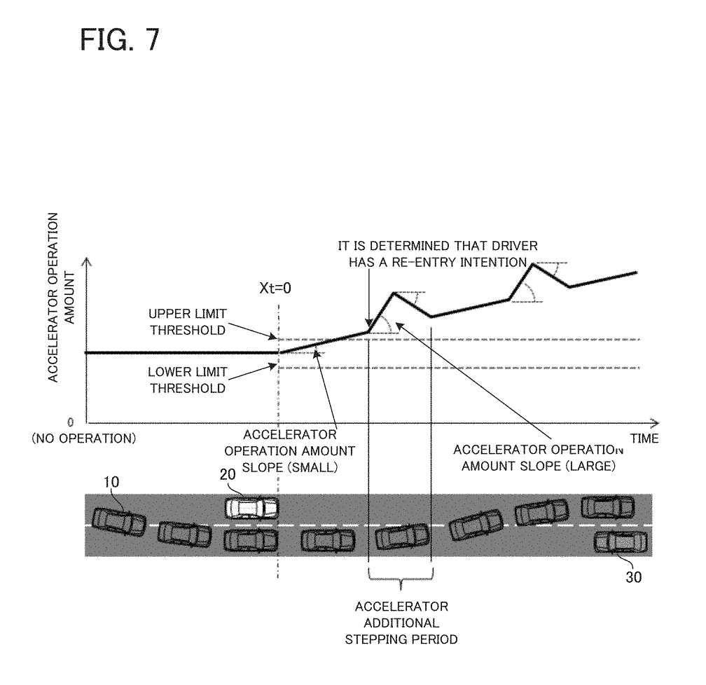

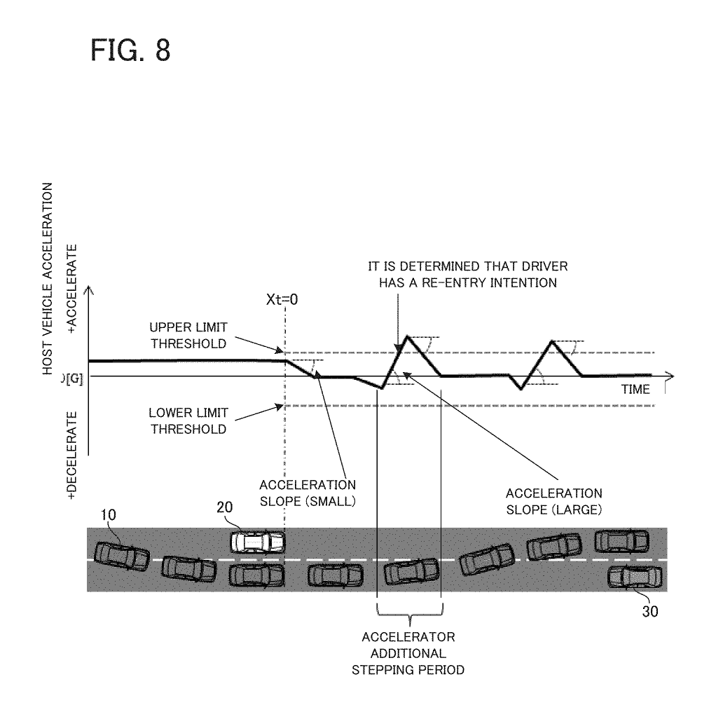

Now, a method of determining the re-entry intention will be specifically explained with reference to FIG. 6 to FIG. 8. FIG. 6 is a conceptual diagram illustrating the method of determining the re-entry intention by using an accelerator operation amount if a speed of the host vehicle is constant. FIG. 7 is a conceptual diagram illustrating the method of determining the re-entry intention by using the accelerator operation amount if the host vehicle is accelerated. FIG. 8 is a conceptual diagram illustrating the method of determining the re-entry intention by using the acceleration of the host vehicle.

As illustrated in FIG. 6 to FIG. 8, whether or not the driver of the host vehicle 10 has a re-entry intention may be determined on the basis of an acceleration operation performed by the driver (which is herein an acceleration operation amount or acceleration on the host vehicle 10). Specifically, the re-entry intention determinator 230 may set an upper limit threshold value and a lower limit threshold value on the basis of the accelerator operation amount or the acceleration when the passing distance Xt is 0. Then, if the accelerator operation amount or the acceleration exceeds the upper limit threshold value and if a slope of the accelerator operation amount or the acceleration is greater than a predetermined slope threshold value, it is determined that the driver of the host vehicle 10 has a re-entry intention.

If the host vehicle 10 is about to pass into an opposite traffic lane and to pass the preceding vehicle 20, it is considered that the driver of the host vehicle 10 may want to accelerate and re-enter the original lane in order to avoid a collision with an oncoming vehicle 30, which runs on the opposite traffic lane. Alternatively, it is also considered that the driver may accelerate in order to compensate for a deceleration caused by a steering operation for re-entering the original lane. It is thus possible to determine the driver's re-entry intention, easily and accurately, by using an acceleration operation of the host vehicle 10.

For example, as illustrated in FIG. 6, in a situation in which the host vehicle 10 keeps an almost constant vehicle speed after the passing, in an accelerator additional stepping period in which a re-entry is intended, the accelerator operation amount exceeds the upper limit threshold value and the slope of the accelerator operation amount is also greater than the predetermined threshold value. As illustrated in FIG. 7, in a situation in which the host vehicle 10 is gradually accelerated after the passing, while an accelerator is gradually additionally stepped, the slope of the accelerator operation amount is not greater than the predetermined threshold value when the accelerator operation amount exceeds the upper limit threshold value. In the accelerator additional stepping period in which the re-entry is intended, however, the accelerator operation amount exceeds the upper limit threshold value, and the slope of the accelerator operation amount is also greater than the predetermined threshold value. As illustrated in FIG. 7, in the case of using the acceleration, in the accelerator additional stepping period in which the re-entry is intended, the acceleration exceeds the upper limit threshold value, and the slope of the acceleration is also greater than the predetermined threshold value. As described above, the use of the accelerator operation amount makes it possible to determine an acceleration intention of the driver of the host vehicle 10

If the acceleration operation amount or the acceleration does not exceed the upper limit threshold value, or if the slope of the acceleration operation amount or the acceleration is not greater than the predetermined threshold value, it may be determined that the driver of the host vehicle 10 does not have a re-entry intention. Moreover, if the acceleration operation amount or the acceleration falls under the lower limit threshold value, it can be determined that the driver of the host vehicle 10 has given up re-entering ahead of the preceding vehicle 20 and has selected to re-enter behind the preceding vehicle (i.e., has stopped the passing operation). Thus, even in this case, it may be determined that the driver of the host vehicle 10 has no re-entry intention.

In the aforementioned example, the re-entry intention is determined on the basis of the acceleration operation of the host vehicle 10; however, the other method may be used to determine the re-entry intention. For example, the re-entry intention may be determined on the basis of a relative position between the host vehicle 10 and the front object, a steering holding state, images of a driver's seat, appearance information (e.g., a line of sight, an operation) of the driver of the host vehicle 10, audio, or the like.

Back in FIG. 2 again, if it is determined that the driver of the host vehicle 10 has no re-entry intention from the passing operation (the step S106: NO), the subsequent process is omitted, and a series of steps is ended. In this case, the vehicle control apparatus 200 may restart the process from the step S101 after a lapse of a predetermined period. On the other hand, if it is determined that the driver of the host vehicle 10 has a re-entry intention from the passing operation (the step S106: YES), the control prohibitor 240 determines whether or not a re-entry of the host vehicle 10 is completed, i.e., whether or not moving ahead of the preceding vehicle 20 is completed (step S107).

If the control prohibitor 240 determines that the re-entry of the host vehicle 10 is completed (the step S107: YES), the subsequent process is omitted, and a series of steps is ended. In this case, the vehicle control apparatus 200 may restart the process from the step S101 after a lapse of a predetermined period. On the other hand, if the control prohibitor 240 determines that the re-entry of the host vehicle 10 is not completed (the step 5107: NO), the control prohibitor 240 prohibits the PCS control, which is performed by the avoidance support controller 210 (step S108).

Then, the control prohibitor 240 determines whether or not the count

T is greater than or equal to 10 seconds (step S109). If the control prohibitor 240 determines that the count T is not greater than or equal to 10 seconds (the step S109: NO), the control prohibitor 240 increases the count T by 1 second (step S110), and repeats the process after the step S106. Thus, until the count T becomes greater than or equal to 10 seconds, the PCS control is continuously prohibited unless it is determined that the driver has no re-entry intention or unless it is determined that the re-entry is completed. On the other hand, if the control prohibitor 240 determines that the count T is greater than or equal to 10 seconds (the step S109: YES), the control prohibitor 240 stops the repetition of the process and ends a series of steps. Thus, even if it is not determined that the driver has a re-entry intention, or even if it is not determined that the re-entry is completed, when the count T becomes 10 seconds, the prohibition of the PCS control is removed. In this manner, it is possible to prevent that the PCS control is unintentionally continuously prohibited. The threshold value of 10 seconds for the count T is merely an example. The threshold value may be set as a value from which it can be determined that a sufficient period elapses after the passing distance Xt becomes 0 meters.

<Technical Effect>

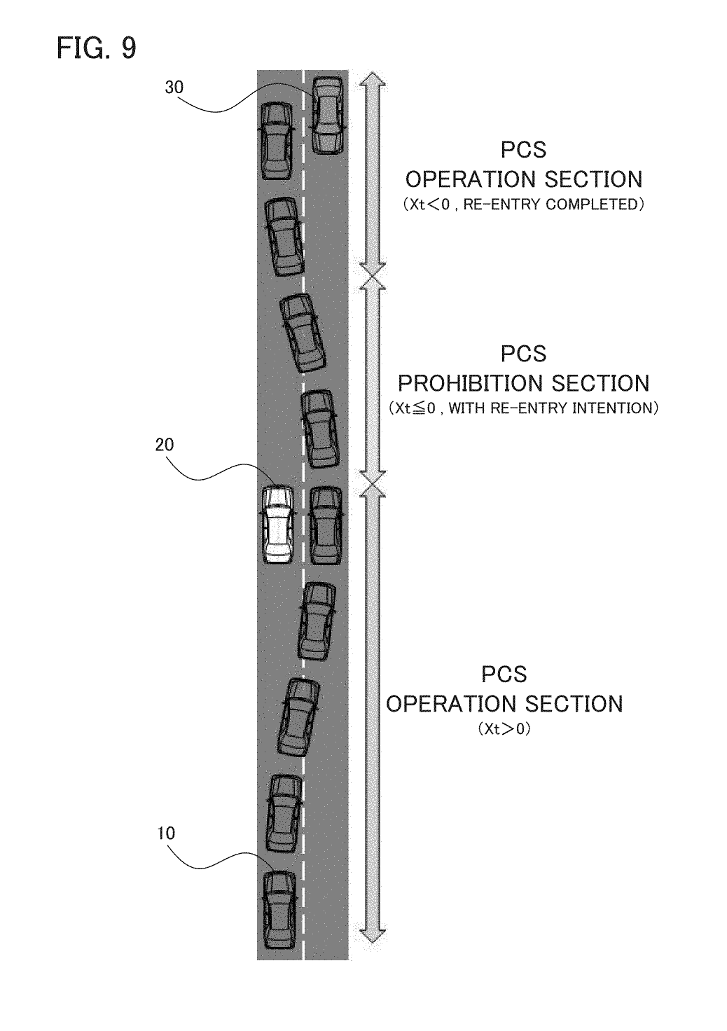

Next, a technical effect obtained by the vehicle control apparatus 200 according to the first embodiment will be explained with reference to FIG. 9.

As illustrated in FIG. 9, according to the vehicle control apparatus 200 in the first embodiment, in the situation in which the passing distance Xt is calculated to have a positive value (i.e., in the situation in which the host vehicle 10 is positioned behind the preceding vehicle 20), or in a situation in which the passing is already completed, the PCS control can be operated. On the other hand, in the situation in which the passing distance Xt is calculated to be less than or equal to 0 (i.e., in the situation in which the host vehicle 10 is positioned ahead of the preceding vehicle 20) and in a situation in which it can be determined that the driver of the host vehicle 10 has a re-entry intention, the PCS control is prohibited.

As described above, by providing a part of section in which the PCS control is prohibited, it is possible to prevent that the implementation of the PCS control merely increases a risk of the collision in the situation in which the host vehicle 10 is about to re-enter ahead of the preceding vehicle 20. For example, in a situation in which the driver of the host vehicle 10 requests to accelerate to re-enter the original lane as soon as possible in order to avoid the collision with the oncoming vehicle 30, if an automatic brake is operated as the PCS control, the behavior of the vehicle may become unstable. According to the vehicle control apparatus 200 in the first embodiment, it is possible to realize a smooth passing operation performed by the host vehicle 10, by preventing the avoidance support control against the driver's intention from being performed.

### Second Embodiment

Next, the vehicle control apparatus 200 according to a second embodiment will be explained. The second embodiment is partially different from the aforementioned first embodiment in the configuration and the operation, but is substantially the same in the other part. Thus, hereinafter, a different part from that in the first embodiment will be explained in detail, and an explanation for the other same part will be omitted, as occasion demands.

<Explanation of Operation>

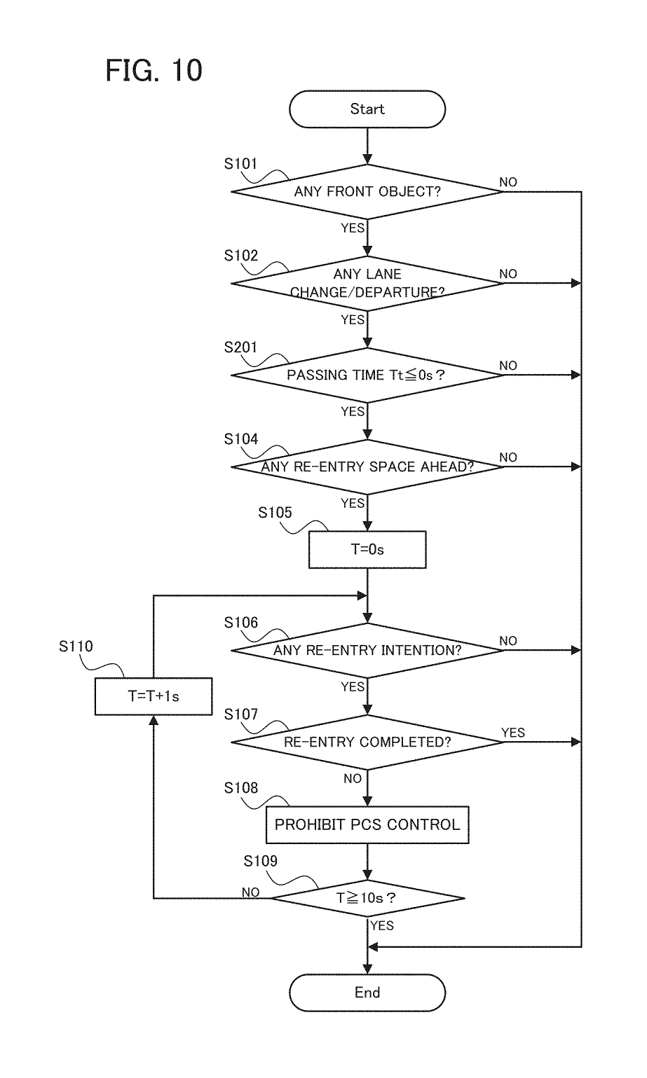

Firstly, the operation of the vehicle control apparatus 200 according to the second embodiment will be explained with reference to FIG. 10. FIG. 10 is a flowchart illustrating a flow of the operation of the vehicle control apparatus according to the second embodiment. In FIG. 10, the same steps as those in the first embodiment illustrated in FIG. 2 carry the same reference numerals.

As illustrated in FIG. 10, in operation of the vehicle control apparatus 200 according to the second embodiment, if it is determined that there is a front object that could be a passing target ahead of the host vehicle 10 (the step S101: YES) and if it is determined that the host vehicle 10 performs a lane change or a lane departure (the step S102: YES), the passing determinator 220 calculates a passing time Tt, which is a time for the host vehicle 10 to pass the front object, and determines whether or not a value of Tt is less than or equal to 0 seconds (step S201). In other words, in the second embodiment, instead of the passing distance Xt in the first embodiment, the passing time Tt is calculated. The value “0 seconds”, which is a threshold value here, is a specific example of the “predetermined time threshold value” in Supplementary Notes described later, and is set as a value for determining whether or not the host vehicle 10 is positioned ahead of the front object.

The passing time Tt can be calculated by solving the following equation (1), wherein V₁ is a speed of the host vehicle 10, A₁ is the acceleration of the host vehicle 10, V₂ is a speed of the front object (e.g., the preceding vehicle 20), and A₂ is the acceleration of the front object.

Xt=(V₁−V₂)×Tt+1/2(A₁−A₂)×Tt² (1)

wherein Xt>0,(V₁−V₂)>0

<Technical Effect>

As explained above, according to the vehicle control apparatus 200 in the second embodiment, it is possible to determine whether or not the host vehicle 10 is positioned ahead of the front object, by using the passing time Tt. Even in this case, as in the first embodiment, it is possible to prohibit the PCS control in appropriate timing.

### Third Embodiment

Next, the vehicle control apparatus 200 according to a third embodiment will be explained. The third embodiment is partially different from the aforementioned first and second embodiments in the configuration and the operation, but is substantially the same in the other part. Thus, hereinafter, a different part from those in the first and second embodiments will be explained in detail, and an explanation for the other same part will be omitted, as occasion demands.

<Explanation of Operation>

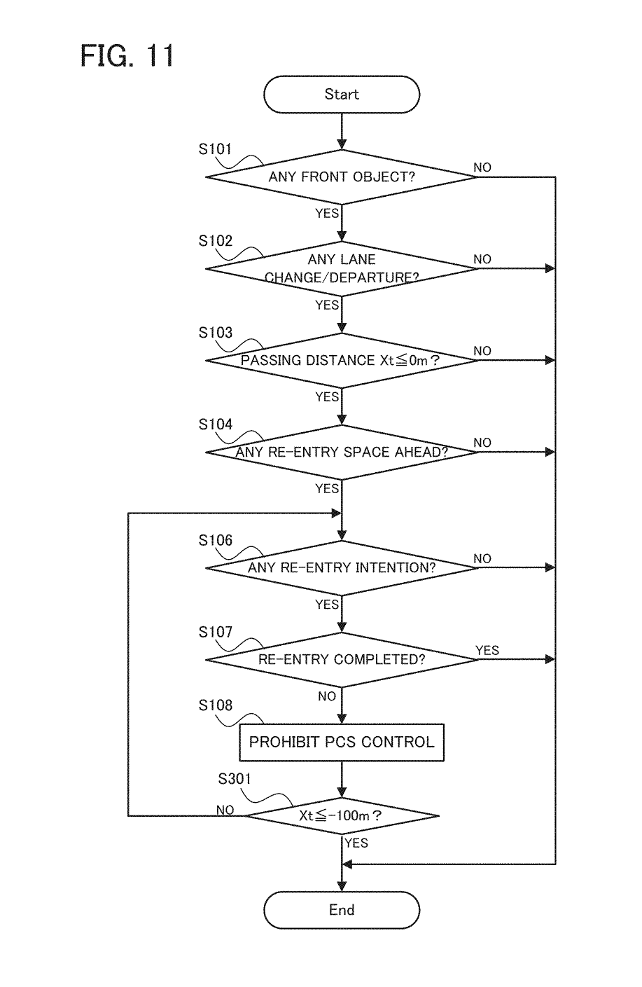

Firstly, the operation of the vehicle control apparatus 200 according to the third embodiment will be explained with reference to FIG. 11. FIG. 11 is a flowchart illustrating a flow of the operation of the vehicle control apparatus according to the third embodiment. In FIG. 11, the same steps as those in the first embodiment illustrated in FIG. 2 carry the same reference numerals.

As illustrated in FIG. 11, in operation of the vehicle control apparatus 200 according to the third embodiment, an end period of the step of prohibiting the PCS control is determined by using the passing distance Xt. Specifically, unlike the first embodiment, the count T (refer to the steps S105, S109, S110 in FIG. 2) are not used, but instead, if the PCS control is prohibited (the step S108), the control prohibitor 240 determines whether or not the passing distance Xt is less than or equal to −100 meters (step S301).

If the control prohibitor 240 determines that the passing distance Xt is not less than or equal to −100 meters (the step S301: NO), the control prohibitor 240 repeats the process after the step S106. Thus, until the passing distance Xt becomes less than or equal to −100 meters, the PCS control is continuously prohibited, unless it is determined that the driver has no re-entry intention or unless it is determined that the re-entry is completed. On the other hand, if the control prohibitor 240 determines that the passing distance Xt is less than or equal to −100 meters (the step S301: YES), the control prohibitor 240 stops the repetition of the process and ends a series of steps. Thus, even if it is not determined that the driver has a re-entry intention, or even if it is not determined that the re-entry is completed, when the passing distance Xt becomes less than or equal to −100 meters, the prohibition of the PCS control is removed.

<Technical Effect>

As explained above, according to the vehicle control apparatus 200 in the third embodiment, it is possible to determine whether or not the prohibition of the PCS control is continued, by using the passing distance Xt. Even in this case, as in the first embodiment, it is possible to prevent that the PCS control is unintentionally continuously prohibited. The threshold value of 100 meters for the passing distance Xt is merely an example. The threshold value may be set as a value from which it can be determined that a sufficient period elapses after the passing distance Xt becomes 0 meters.

### Fourth Embodiment

Next, the vehicle control apparatus 200 according to a fourth embodiment will be explained. The fourth embodiment is partially different from the aforementioned first to third embodiments in the configuration and the operation, but is substantially the same in the other part. Thus, hereinafter, a different part from those in the first to third embodiments will be explained in detail, and an explanation for the other same part will be omitted, as occasion demands.

<Explanation of Operation>

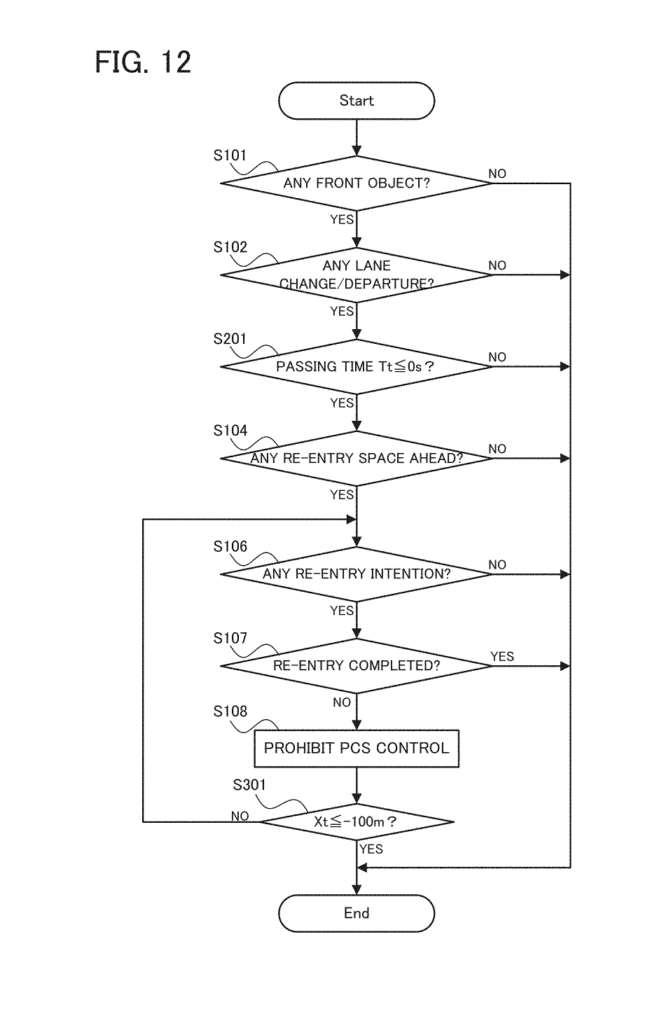

Firstly, the operation of the vehicle control apparatus 200 according to the fourth embodiment will be explained with reference to FIG. 12. FIG. 12 is a flowchart illustrating a flow of the operation of the vehicle control apparatus according to the fourth embodiment. In FIG. 12, the same steps as those in the first to third embodiments illustrated in FIG. 2, FIG. 10, and FIG. 11 carry the same reference numerals.

As illustrated in FIG. 12, in operation of the vehicle control apparatus 200 according to the fourth embodiment, if it is determined that there is a front object that could be a passing target ahead of the host vehicle 10 (the step S101: YES) and if it is determined that the host vehicle 10 performs a lane change or a lane departure (the step S102: YES), the passing determinator 220 calculates a passing time Tt, which is a time for the host vehicle 10 to pass the front object, and determines whether or not a value of Tt is less than or equal to 0 seconds (the step S201). In other words, the same process as in the second embodiment is performed.

On the vehicle control apparatus 200 according to the fourth embodiment, moreover, if the PCS control is prohibited (the step S108), the control prohibitor 240 determines whether or not the passing distance Xt is less than or equal to −100 meters (the step S301). Then, if the control prohibitor 240 determines that the passing distance Xt is not less than or equal to −100 meters (the step S301: NO), the control prohibitor 240 repeats the process after the step S106. On the other hand, if the control prohibitor 240 determines that the passing distance Xt is less than or equal to −100 meters (the step S301: YES), the control prohibitor 240 stops the repetition of the process and ends a series of steps. In other words, the same process as in the third embodiment is performed.

<Technical Effect>

As explained above, according to the vehicle control apparatus 200 in the fourth embodiment, it is possible to determine whether or not the host vehicle 10 is positioned ahead of the front object, by using the passing time Tt. Thus, as in the second embodiment, it is possible to prohibit the PCS control in appropriate timing. Moreover, on the vehicle control apparatus 200 according to the fourth embodiment, it is possible to determine whether or not the prohibition of the PCS control is continued, by using the passing distance Xt. Thus, as in the third embodiment, it is possible to prevent that the PCS control is unintentionally continuously prohibited.

<Supplementary Notes>

Various aspects of embodiments of the present disclosure derived from the embodiments explained above will be explained hereinafter.

(Supplementary Note 1)

A vehicle control apparatus described in Supplementary Note 1 is provided with: an avoidance supporter configured to perform an avoidance support control for avoiding a collision between a host vehicle and an object that exists around the host vehicle; a determinator configured to determine, while the host vehicle is passing a front object that exists on a first driving lane, (i) whether or not a distance between a first part of the host vehicle and a second part of the front object is less than or equal to a predetermined distance threshold value, or (ii) whether or not a time required for the first part of the host vehicle to reach a position corresponding to the second part of the front object is less than or equal to a predetermined time threshold value; a detector configured to detect a re-entry intention of a driver of the host vehicle who intends to move the host vehicle ahead of the front object and a position in the first driving lane, if it is determined that the distance is less than or equal to the predetermined distance threshold value, or if it is determined that the time is less than or equal to the predetermined time threshold value; and a controller programmed to control the avoidance supporter not to perform the avoidance support control if the re-entry intention is detected.

According to the vehicle control apparatus described in Supplementary Note 1, if it is determined that the distance or time required for the host vehicle to be positioned ahead of the front object that is being passed is less than or equal to the predetermined threshold value, and if the re-entry intention of the driver of the host vehicle (which is specifically a re-entry intention to a position ahead of the front object and on the driving lane on which the front object exists (or travels), the avoidance support control for avoiding the collision is not performed. This makes it possible to prevent the avoidance support control against the driver's re-entry intention from being performed, which results in more appropriate collision avoidance.

(Supplementary Note 2)

In the vehicle control apparatus described in Supplementary Note 2, the detector is configured to detect the re-entry intention, on the basis of an acceleration operation of the host vehicle by the driver of the host vehicle after it is determined that the distance is less than or equal to the predetermined distance threshold value, or after it is determined that the time is less than or equal to the predetermined time threshold value.

While passing, the driver may want to accelerate the host vehicle in order to be positioned ahead of the front object that has been passed, as early as possible. Alternatively, the driver may want to accelerate the host vehicle in order to compensate for a deceleration caused by a steering operation for moving to the first driving lane. It is thus possible to detect the driver's re-entry intention, easily and accurately, on the basis of the acceleration operation of the host vehicle.

The present disclosure may be embodied in other specific forms without departing from the spirit or essential characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A vehicle control apparatus comprising:
an avoidance supporter configured to perform an avoidance support control for avoiding a collision between a host vehicle and an object that exists around the host vehicle;
a determinator configured to determine, while the host vehicle is passing a front object that exists on a first driving lane, (i) whether or not a distance between a first part of the host vehicle and a second part of the front object is less than or equal to a predetermined distance threshold value, or (ii) whether or not a time required for the first part of the host vehicle to reach a position corresponding to the second part of the front object is less than or equal to a predetermined time threshold value;
a detector configured to detect a re-entry intention of a driver of the host vehicle who intends to move the host vehicle ahead of the front object and a position in the first driving lane, if it is determined that the distance is less than or equal to the predetermined distance threshold value, or if it is determined that the time is less than or equal to the predetermined time threshold value; and
a controller programmed to control said avoidance supporter not to perform the avoidance support control if the re-entry intention is detected.

2. The vehicle control apparatus according to claim 1, wherein said detector is configured to detect the re-entry intention, on the basis of an acceleration operation of the host vehicle by the driver of the host vehicle after it is determined that the distance is less than or equal to the predetermined distance threshold value, or after it is determined that the time is less than or equal to the predetermined time threshold value.
